(19) United States
(12) Patent Application Publication
(10) Pub. No.: US 2010/0045989 A1
(43) Pub. Date: Feb. 25, 2010

(54) Method and device for monitoring the condition of a medium

(76) Inventors: Jarmo Vanhanen, Kausala (FI); Marcus Rinkiö, Jyvaskyla (FI); Paivi Törmä, Espoo (FI); Jouko Korppi-Tommola, Saynatsalo (FI); Kari Loberg, Korpilahti (FI); Jukka Elfström, Jyvaskyla (FI)

Correspondence Address: FILDES & OUTLAND, P.C., 20916 MACK AVENUE, SUITE 2, GROSSE POINTE WOODS, MI, 48236, US

(21) Appl. No.: 12/311,037

(22) PCT Filed: Sep. 17, 2007
(86) PCT No.: PCT/FI2007/050495

§ 371 Date: Mar. 17, 2009

(30) Foreign Application Priority Data
Sep. 20, 2006 (FI) 20065575

(51) Int. Cl. G01N 21/00

(52) U.S. Cl. 356/432

(57) ABSTRACT

The invention relates to a method for monitoring the condition of a medium in a channel, based on the transmission/emission of light, in which
a light at a set wavelength is conducted through a medium layer defined by a measuring gap in a measuring head pushed in from an opening in the wall of the channel
the intensity of the light passed through medium layer, or a variable proportional to it is measured, and
the condition of the medium is evaluated, using measuring electronics, from the change of the intensity, according to established criteria. In the method, the wavelength of light used is such that the resolution of the aging phenomenon of the medium being monitored is optimal and the relationship of the temperature dependence of the medium to the measuring variable is taken into account. In addition, the invention also relates to a corresponding device.

The present invention relates to a method for monitoring the condition of a medium in a channel, based on the transmission/emission of light, in which
a light at a set wavelength is conducted through a medium layer defined by a measuring gap in a measuring head pushed in from an opening in the wall of the channel,
the intensity of the light passed through the medium layer, or a variable proportional to it is measured, and
the condition of the medium is evaluated, using measuring electronics, from the change of the intensity, according to established criteria.

In addition, the invention also relates to a corresponding device.

Lubricating and hydraulic oils are of two main grades, mineral oils and synthetic oils. The pressure resistance of the oils, the temperature dependence of their viscosity, and many other properties are improved by using various additives. The popularity of synthetic oils has increased, due to, among other factors, their greater durability.

The aging of oil appears mainly in the fragmentation of long hydrocarbon chains, when this chemical change results in a decisive change in the physical properties of the oil. On the other hand, foreign substances, such as particularly metal particles from transmission components and combustion residues in combustion engines, become mixed with the oil. Old oil of poor quality cannot carry out its task, for example, the lubrication of machine elements. This will be inevitably followed by engine failure, unless the oil is changed.

The condition of mineral oil worsens evenly over time as the oil is used. On the other hand, synthetic oils are characterized by their condition collapsing quite rapidly after a reasonably even period. The monitoring of the condition of lubricating and hydraulic oils is essential to ensure the continued operation of machines.

DE publication 102 08 134 A1 discloses a sensor, in which a light, from the intensity of which the condition of a medium can be determined, is led through a layer of the medium defined by a measuring gap in a measuring head pushed in through an opening in the wall of a channel. However, the publication does not deal with the arrangement of the measuring electronics associated with the device, which is challenging, for example, due to the temperature conditions of the medium. In addition, conducting the light beam from the light source to the measuring head and returning it from the measuring head to the detectors takes place by utilizing the plastic body component of the device. The light is bound to disperse in the body component, in which case its intensity will also decrease, due to the effect of the body component. The publication does not refer to the wavelength of the light used.

EP patent number 0 806 653 B1 is known from the prior art. In it, light in the infrared range is used. The scientific publication according to reference [1] proposes using light, the wavelength of which is in the infrared range.

In addition to the above factors, a challenge is also set by the conditions prevailing at the measuring point, which may, in certain applications, vary even greatly, for example, according to the time of year, or even the time of day.

The present invention is intended to create a method and device, which is more sensitive, reliable in operation and stable in long-term use than previously, for measuring the conditions of a medium, for example lubricating or hydraulic oil. The characteristic features of the method according to the invention are stated in the accompanying Claim 1 and the characteristic features of the corresponding device in Claim 9.

According to the invention, the wavelength of light used is such, by means of which the resolution of the aging phenomenon of the medium being monitored in optimal and, in addition, in the invention allowance is made for the temperature-dependence of the measuring variable of the medium.

According to one embodiment, measurement is performed using a light, the wavelength of which is in the range 300 nm-600 nm and even more particularly in the range 450 nm-500 nm.

The invention is based on the applicant's important observation that the wavelength, at which resolution of the aging phenomenon of the medium is optimal, varies between different qualities of the medium. According to one embodiment, it is possible to use in the measurement, for example, a wavelength of light that is, for example, in the ultraviolet range (i.e. a high frequency). In addition, by taking the relationship of the temperature-dependence of the medium to the measuring medium into account, the measurement results can made comparable and veracious, and thus the accuracy of the measurement can be increased. It has been observed that by not taking the relationship of the temperature-dependence of the medium to the measuring medium into account, the change in the measurement result arising from the change in the temperature can be even greater than the change caused by the change in the properties of the medium itself.

In the wavelength range according to the invention, a surprisingly greater differentiation between different oil grades is obtained. This improves the quality of the monitoring and thus gives it certainty. By, in addition, selecting the wavelength range on the basis of the medium being monitored, and more particularly by adapting the wavelength range, for example, according to the wavelength range/sensitivity characteristic for the degradation of the molecules of the medium, the quality of the monitoring can be surprisingly improved.

Other benefits and additional embodiments of the invention are described hereinafter, in connection with the examples of applications.

In the following, the invention is examined in detail with reference to the accompanying drawings showing some applications of the invention, in which

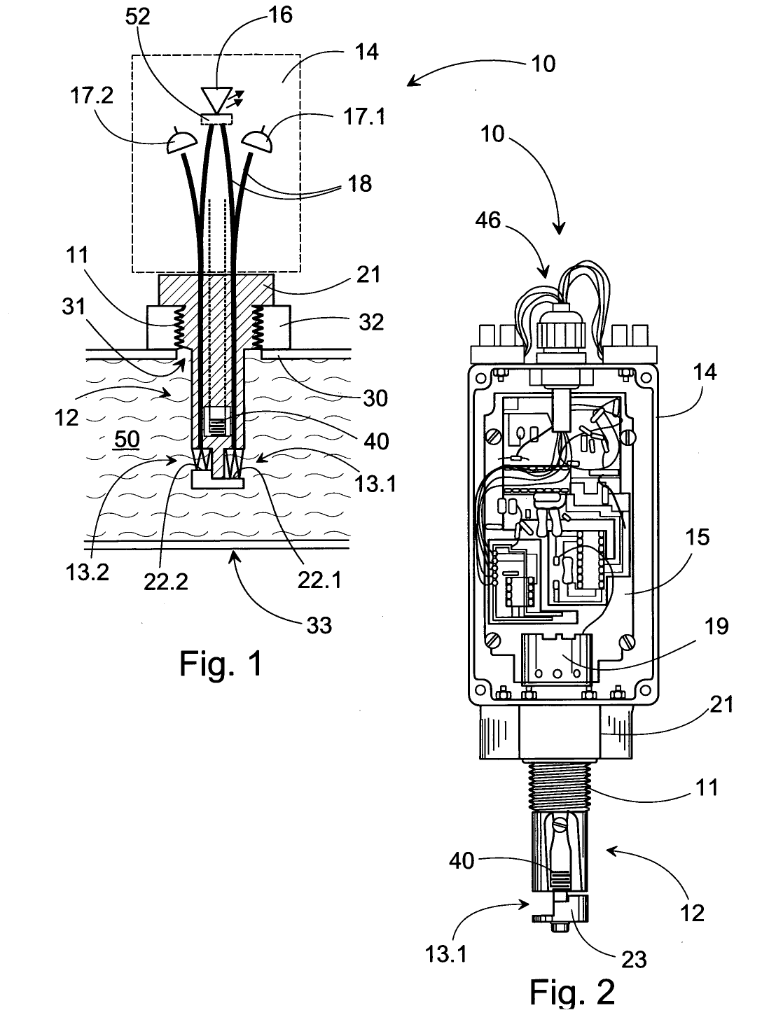

FIG. 1 shows schematically the method according to the invention,

FIG. 2 shows the device according to the invention with the device case opened,

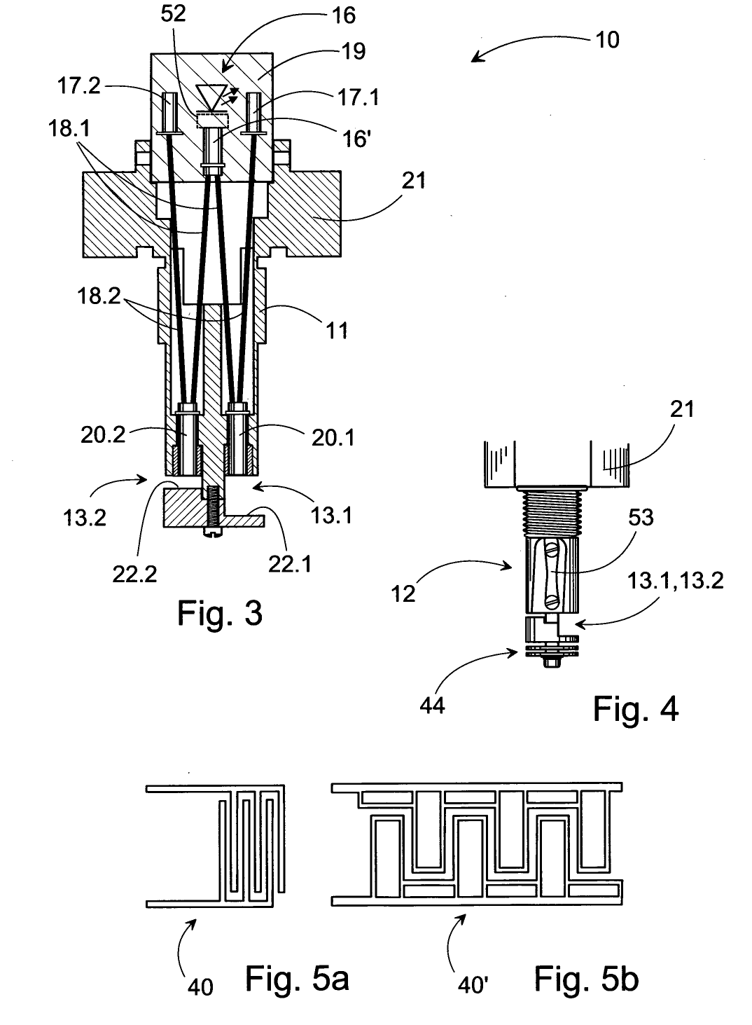

FIG. 3 shows the arrangement of the light source and the detectors and of the optical fibres in the measuring head,

FIG. 4 shows one variation of the invention, in which a plate capacitor is used,

FIGS. 5a, 5b show some examples of geometries of the micro-element,

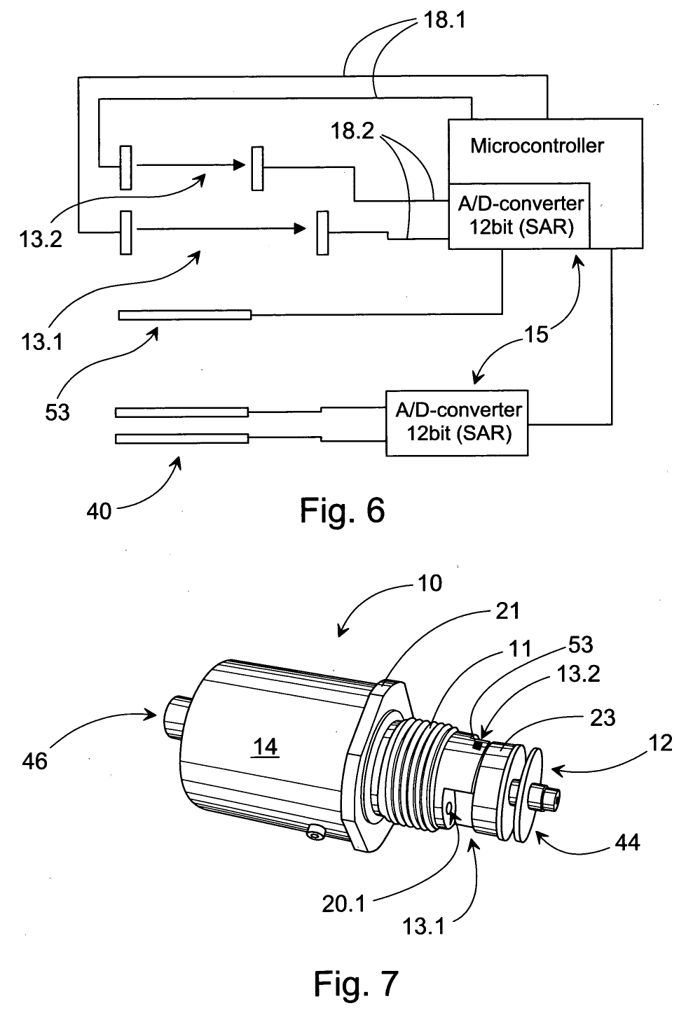

FIG. 6 shows a schematic diagram of the device in principle,

FIG. 7 shows one improved prototype of the device,

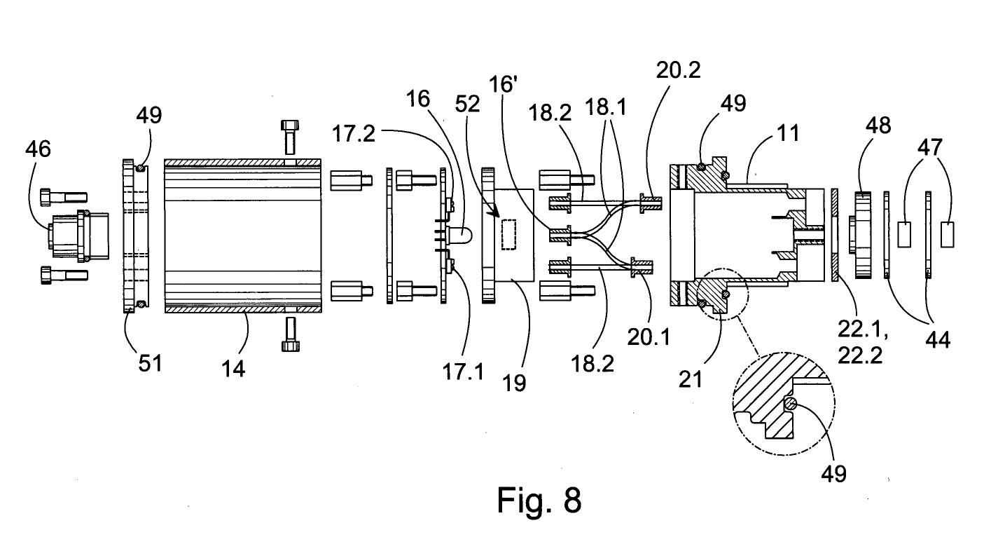

FIG. 8 shows an exploded view of a detail of an example of an improved version of the device,

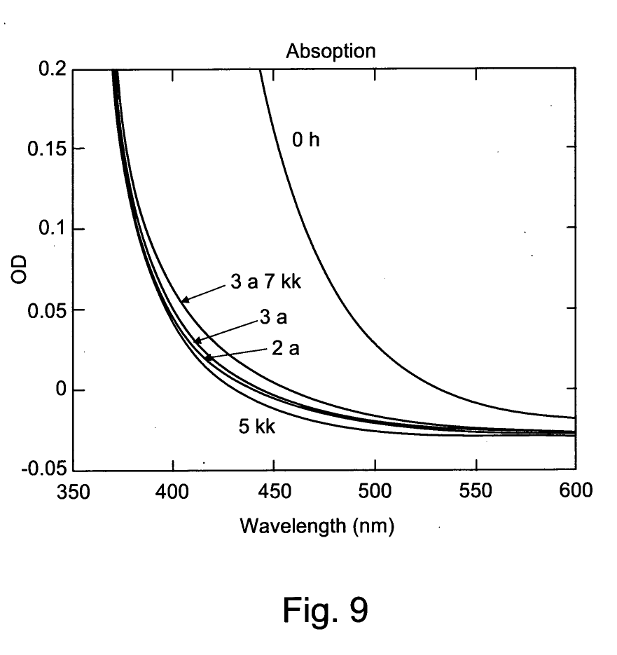

FIG. 9 shows an example of a graph of optical density as a function of the wavelength of the light,

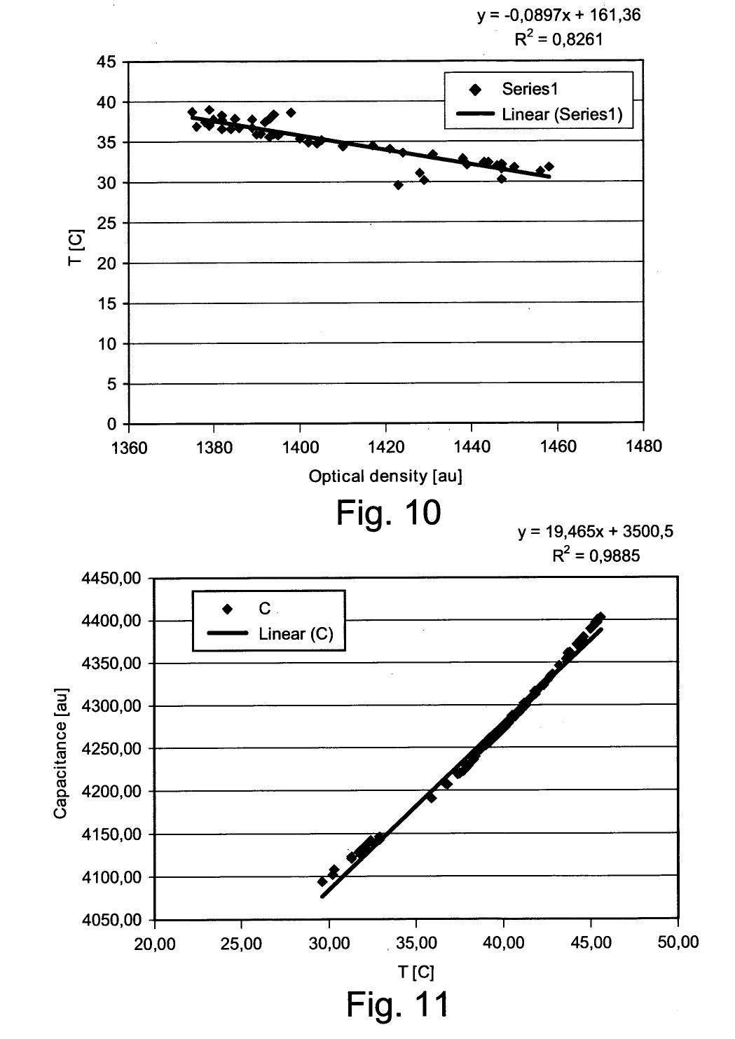

FIG. 10 shows an example measurement of the temperature dependence of absorption, and

FIG. 11 shows an example measurement of the temperature dependence of capacitance.

FIG. 1 show one example of the device 10 for monitoring the condition of a medium 50 in a channel 33, based on the transmission/emission of light. In the schematic presentation of FIG. 1, the measuring head of the device 10 monitoring the condition of lubricating oil 50, for example, is marked with the reference number 12. It is attached to a body component 21, in which there are threads 11 for attaching the device 10 to the wall 30 of a channel 33. The measuring head 12 can be pushed in from an opening 31 in the wall 30 and the entire device 10 screwed into the wall 30, for example, into a counter nut 32, which is at the opening 31, arranged by welding. The counter surfaces include a ring seal 49 (FIG. 8). The device according to the invention can be easily arranged at a selected point in the channel 33, and thus does not require any special construction in the channel 33 or the installation point. Within the concept of the invention, the channel 33 can be understood very widely. Besides being a flow channel, it can also be, for example, a part of a tank, in which the medium 50 changes at least nominally.

The measuring head 12 includes at least one, however preferably two optical measuring gaps 13.1 and 13.2, which define the layer thicknesses of the lubrication medium being examined. The measuring gaps 13.1, 13.2 are at the free end of the measuring head 12, which is inside the channel 33 and which is the extreme end in the liquid 50 of the elongated device 10, being thus at the opposite end to the device case 14.

The light source 16 and the light detectors 17.1, 17.2 are located outside the measuring head 12 and in this case also clearly outside the channel 33. The light source, which in this case is one LED 16, and the detectors 17.1, 17.2 are connected by optical fibres 18 to the measuring means 13.1, 13.2. Examples of these are shown in greater detail slightly later. A LED component 16, at the wavelength of the light produced by which the resolution of the aging phenomenon of the medium 50 being illuminated is optimal. The medium being illuminated can be different grades of oil. Such a LED can operate in the ultraviolet range, for example. The light produced by the LED 16 can be continuous. On the other hand, the LED 16 can also be pulsed by a micro-controller in a desired manner. If pulsed, the operating life of the LED 16 can be lengthened.

The wavelength range of the LED 16 can be generally 300 nm-600 nm, more specifically 400 nm-500 nm. According to one embodiment, a so-called short UV range, for example 300 nm-400 nm, can be used. In the pilot stage of the research, it was observed that for a specific oil grade (Mobile XMP 320) the best resolution was obtained at a wavelength of the light source 16, which was 425 nm-500 nm, more specifically 450 nm-480 nm, and especially 472 nm, i.e. at the wavelength of blue light. The use of other wavelengths is, of course, also possible, for example, depending on the optimality of the resolution of the aging phenomenon of the medium or medium grade being analysed, and thus of the medium 50 being monitored at the time. It may be possible to apply even smaller wavelengths, if only the measuring electronics provide the capability for this.

The wavelength range/sensitivity of the light can also be selected in such a way that, for example, the characteristic wavelength/sensitivity of the fragmentation of the molecules of the medium 50 is selected. Instead of a LED component, a GaN laser, for example, can also be used. The light source is selected according to the wavelength being used. On the other hand, the wavelength range of the light can also be adjusted in connection with the measurement, for example by controlling the operation of the LED 16, or by control means, which can be in connection with the optical fibres 18, 18.1, for example, and thus influence the quality of the light produced by the LED 16. FIG. 9 shows an application example of how the optical density (i.e. the absorption of light) changes as a function of the wavelength. It shows that for the grade of oil in question (Mobile XMP 320) the optimal resolution of the aging phenomenon is achieved in the wavelength range 450 nm-500 nm. The graph can be different in the case of each oil grade, so that the wavelength achieving the optimal resolution can be different for different grades of oil.

The intensity of the LED 16 too can be adjusted. Thus, the media being analysed by the same device, for example the scale of oils, can be expanded. If, in addition to the wavelength range (mechanical adjustment according to the selected LED), the intensity of the light (electronic adjustment) is adjusted oil-grade-specifically, combined mechanical and electronic adjustment can be implemented. A possible overload coming to the receiver 17.1, 17.2 can be avoided by adjusting the intensity of the LED 16 measurement-specifically. Alternatively, the intensity can also be adjusted mechanically by altering the measuring gap. Besides altering the measuring gap, electronic adjustment in a selected manner can also be performed, in which case it is also possible to refer to combined adjustment. The adjustment of the strength of the light source 16 and the adjustment of the magnitude of the measuring gap 13.1, 13.2 can also be applied, particularly to clear oils.

In the measuring head 12 there is, in addition, a possible micro-element 40 for capacitive and resistive measurements. Instead of, or in addition to the micro-element, a capacitive plate sensor can also be applied, which has a better resolution than the micro-element. This provides information that is independent of the optical measurement, which can be used to improve the reliability of the results and possible to expand the measurement range of the device 10. In addition, the use of such a dual sensor achieves a surprising advantage, for example, in the form of determining water content, besides it being able to be used to check the optical measurement, i.e. to be certain that the trends of both measurements are in the same direction.

In FIG. 2, the device is shown in its entirety with the cover of the device case open and in FIG. 7 one improved prototype of the device enclosed. In practice, the measuring head 12 is integrated in the pieces formed by the body 21. The body 21 and the measuring head 12 can be, for example, moulded from POM plastic. The device case 14 is attached to the opposite side of the body 21 relative to the measuring head 12. The device case 14 contains an electronic circuit card 15, which includes, among other things, the circuit required for computation and the necessary A/D converters.

FIG. 3 shows one embodiment of an optical measuring arrangement in detail, by means of which the condition of a medium 50 can be monitored, based on the transmission/emission of light in a channel 33. The condition of the medium 50 is evaluated using measuring electronics 15 from the change in intensity caused by the medium 50 to a light beam, according to set criteria. For example, the absorption of light into the medium 50, i.e. the darkening of the medium 50, can indicated a deterioration in the condition of the medium 50. The condition of the medium 50 can refer, for example, to the lubricating properties of the medium 50, which can depend of the fragmentation of molecules of the medium 50, or on foreign substances in the medium 50. In the invention, the measurement is performed using a sensor 10, in which a measuring gap 13.1, 13.2 is fitted in a compact elongated measuring head 12. The measuring electronics 15 of the device 10 are essentially outside the channel 33. The LED component 16 and the light detectors 17.1, 17.2 are located at a distance from the measuring gaps 13.1, 13.2, being securely in a plastic piece 19, which is attached to the body 21.

Light at the set wavelength is conducted through the layers of the medium defined by the measuring gaps 13.1, 13.2 in the measuring head 12 pushed in from the opening 31 in the wall 30 of the channel 33. The layers of the medium form at least part of the medium 50 flowing in the channel. In the device 10, optical fibres 18.1 and 18.2 are used as the means for conducting the light beam from the light source 16 to the measuring gaps 13.1, 13.2 and back from them. By means of the fibres 18.1, the light produced by the LED component 16 is conducted to the measuring gaps 13.1, 13.2 and correspondingly by the fibres 18.2 back from the measuring gaps 13.1, 13.2 to the light sensors 17.1, 17.2. The detection means of the device 10 include a dedicated light detector 17.1, 17.2 for each of the measuring gaps 13.1, 13.2, which is connected by the optical-fibre conductor 18.2 to the measuring gap 13.1, 13.2 corresponding to it, in order to conduct the light beam, which has passed through the layer, from the measuring gap 13.1, 13.2 in question to the corresponding light detector 17.1, 17.2. In connection with both measuring gaps, 13.1, 13.2, the fibres 18, 18.1, 18.2 are joined to the corresponding same fibre terminal 20.1 and 20.2. Correspondingly, the fibres 18.1 conducting the light to the measuring gaps 13.1, 13.2 are in the same common fibre terminal 161, at their end next to the light source 16.

The transmission and reception fibres 18.1, 18.2 are thus joined together in the measuring head 12. In connection with the light source 16, it is possible to use special means 52 for focusing the light beam, though increasing the power of the LED will generally provide a simpler way to increase the measuring gap. As well as, or instead of the light source 16 the detection means 17.1, 17.2 and/or the optical-fibre conductors 18.1, 18.2 can include means 52 for focusing the light beam.

Thus the body component 21 includes a measuring head 12, at the end of which there is a reflector piece 23. In it there are reflective surfaces 22.1 and 22.2 in both measuring gaps 13.1, 13.2, which are on the opposite side of the measuring gap 13.1, 13.2 to the light source 16 and the light detectors 17.1, 17.2. Thus at least one measurement can be made against the surface 22.1, 22.2 reflecting the light beam. The application of a reflecting surface 22.1, 22.2 in the measuring head 12 has the advantage that the detectors 17.1, 17.2 can be located on the same side of the medium layer 13.1, 13.2 being measured as the light source 16. The total travel of the light beam in the oil becomes twice the physical gap 13.1, 13.2. According to one embodiment, the measuring gaps 13.1, 13.2 can be, for example, 6 mm and 9 mm. In that case the light beam travels correspondingly the distances of 12 mm and 18 mm. The use of measuring gaps of this order of magnitude gives an optimal measurement range for different oil grades, by also adjusting the intensity of the LED 16. The ratio of the measuring gaps 13.1, 13.2 can then be, for example, 1:1.5±50%. The spaces formed by the measuring gaps 13.1, 13.2 can be anodized black, so that they will not cause detrimental reflections.

Instead of, or even in addition to the micro-element 40 shown in FIG. 1, it is possible to use, for example, a gold-plated plate capacitor 44 according to FIG. 4. The effect of the thermal expansion of the plate capacitor 44 on the capacitance can be compensated using a micro-controller, which receives information from a temperature sensor 53. FIG. 11 shows an example of the temperature dependence of the capacitance. Various shapes of the micro-element 40, 40′ are shown in FIGS. 5a and 5b.

The device 10 can be used to monitor the condition of liquid substances 50, such as oils. Its operation is based on the measurement of the absorption, as well as possibly also of the electrical properties, such as the capacitance and/or the resistance, of the oil 50. The operation of the device 10 takes place as follows. The light produced by a LED acting as a light source 16 for both measuring gaps 13.1, 13.2 is guided, i.e. divided into two input fibres 18.1, i.e. to the measurement. The fibres 18.1 conduct the light to reflective surfaces 22.1, 22.2 in a measuring head 12 in the oil 50. The light is absorbed in the oil 50 and reflected back from the mirror surfaces 22.1, 22.2 and the light that has travelled through the oil 50 is collected by fibres 18.2 going to detectors 17.1, 17.2. In other words, in the method the detector means 17.1, 17.2 are used to measure the intensity, or a variable proportional to it, of the light beam that has passed through the medium layer defined by two measuring gaps 13.1, 13.2 of different thicknesses. The light coming from the different fibres 18.1 travels for a different distance through the oil, and is thus absorbed differently. The measurement of the difference in absorption surprisingly compensates, for example, for the effect of the dirtying of the reflector surfaces 22.1, 22.2, so that a more precise measurement is obtained and error sources can be removed computationally.

The measuring electronics 15 of the device 10 are used to analyse intensity, or a corresponding variable, of the light, obtained from the detector means 17.1, 17.2 that has passed through the medium layer. The electronics 15 are used to detect a possible change in the measured intensity while a selected numerical analysis method (arithmetical processing) performed on its basis can be used to estimate the condition of the medium.

By using optical fibres 18.1, 18.2 and simultaneous measurement over two measuring gaps 13.1, 13.2 of different sizes, the dirtying of the reflector surfaces 22.1, 22.2 is compensated for. By using compensation and in addition by combining two different forms of measurement, errors caused by both the weakening of the light source 16 and/or the dirtying of the reflective surfaces 22.1, 22.2 are effectively eliminated. It has been observed experimentally that, for example, the absorption and capacitance/resistance of the oil correlate with its operating age.

Real-time monitoring of the condition of oil facilitates the maintenance of equipment and the detection of a need for maintenance. Practical applications include all liquid oils, which are used, for example, in industrial gears and devices, as well as oils in which changes occur during use and storage.

### Measuring Head

The sensor 10 is intended to monitor the condition of the oil 50, by measuring the absorption of the oil, i.e. the transmission/emission of light in the oil 50, as well as additionally the electrical properties of the oil 50, such as its capacitance and/or resistance, more generally stated the dielectricity and/or resistivity of the medium. In that case, the two different methods of measuring a property of the oil 50 surprisingly complement each other to provide information and improve the sensor's 10 ability to detect various changes in the condition of the oil 50.

All of the materials of the measuring head 12 that come into contact with the oil 50 are of an oil-resistance grade. The component below the threads 11 is the measuring head 12 in the oil 50, in which the fibres 18.1, 18.2, the reflecting mirror surfaces 22.1, 22.2, and the micro-element 40 are secured. The part above the thread 11 is a case 14, inside which are the electronics 15. The principle of construction of the measuring head 12 is shown above in FIG. 1. The part shown by the broken line contains the electronics (device case).

### Optical Sensing Element and its Operation

In the measurement of the absorption of the oil 50, the light is guided to the oil 50 and out of it by optical fibres 18.1, 18.2 inside the measuring head 22 (FIG. 1). Absorption is measured using two beams, which are reflected in the measuring gaps 13.1, 13.2 from reflecting mirror surfaces 22.1, 22.2 at different distances and thus travel for different distances through the oil 50. In this way, two intensities are measured, so that the condition of the oil 50 can be monitored using a chosen numerical analysis method utilizing these intensities.

The measurements are made using two different light beams at a distance from each other in physically separated measuring means 13.1, 13.2. The use of this method is intended to measure the relative difference (and change) of the absorptions and thus to compensate for the possible dirtying of the mirror surfaces 22.1, 22.2, variations in the power of the light source 16, and/or in general for effects on the measurement value due to the dispersion of the components, so that the measurement result obtained would only be affected by the absorption (or emission) of the oil 50. The light source is the same LED 16, so that light conducted to both measuring gaps will be of as equal quality as possible, at least in the case of the light source 16.

The measured intensity I of the light is affected not only by the absorption of the light in the oil 50, but also by the widening of the light beam leaving the fibres 18.1, 18.2, after it has left the fibre 18.1. Due to the widening, a smaller part of the reflected light will strike the fibre 18.2 going to the detectors 17.1, 17.2 the longer the distance d travelled by the light outside the fibre 18.1. The cross-sectional surface area A of the light beam affects the distance d and the widening angle θ of the light beam, i.e. A=π (d tan θ)². In addition, the possible dirtying of the reflector surfaces 22.1, 22.2 or the ends of the fibres 18.1, 18.2 will reduce the amount of light of the fibre 18.2 going the to detectors 17.1, 17.2 by the factor k, if it is assumed that the dirtying takes place evenly in both measuring gaps 13.1, 13.2. The absorption of light caused by the oil 50 is obtained from the equation I=I₀ exp(−αd), in which a is the absorption factor. The detected intensity of the light can be regarded as consisting of so that

I=k*A₀/A*I₀ exp(−αd)

in which A₀ is the surface area of the light beam, when d=0, i.e. A₀=the surface area of the end of the fibre 18.1. The outputs of the different beams of the measuring head 12 are thus

I(d₁)=k*A₀/A₁*I₀ exp(−αd₁)

I(d₂)=k*A₀/A₂*I₀ exp(−αd₂)

in which A_{1, 2} is the surface area of the light beam, α is the absorption of the oil, and d_{1,2} is the distance travelled by the light. By distributing the intensities between themselves, only the value dependent on the absorption of the oil is obtained

[symbol]

I(d₁)/I(d₂)=A₂/A₁ exp (−α(d₁−d₂))=(d₁/d₂)² exp (−α(d₁−d₂))

in which d₁ is the shorter distance.

The applicant has made the significant observation that the temperature of the oil 50 affects the absorption of the oil 50. For this reason, in certain applications it is possible to use a LED transmitting infrared light 800-1500 nm, because in that wavelength range the effect of the temperature is probably not so significant.

According to the method of the invention it is also possible to take into account the temperature dependence of the medium 50 relative to the measuring variable. This can be implemented, for example, as compensation for the temperature dependence of the dielectricity and absorption, for example, as mathematical compensation and/or temperature stabilization of the medium 50.

The device 10 can be calibrated for different temperatures, which is also measured using the sensor 53. The sensor 53 can be located, for example, at the end of the measuring head 12 and can be used to measure, for example, the temperature of the measuring head 12, which corresponds with a small delay to the temperature of the oil 50. Through the calibration, the different temperatures receive their own tables/graphs, from which the correspondence of the measuring signals at different temperatures can be sought. More generally, it is possible to speak of measurement-technical classification according to temperature, performed using the measuring electronics 15.

FIG. 10 shows some examples of measurement results and a graph adapted on their basis of the temperature dependence of the absorption (the optical density in the graph) and in FIG. 11 of the temperature dependence of the capacitance. The measurements were performed within a period of about one day, i.e. the oil had not significantly aged during that time. However, the values of the measurements change substantially according to the temperature. Another way to compensate for the temperature dependence of the medium 50 is temperature stabilization of the medium 50. In it, the temperature of the medium 50 travelling through the sensor 10 is set to a desired constant value, thus eliminating the need for mathematically performed compensation.

Even through measurement based on transmission is often the most advantageous, with the aid of the method it is also possible to utilize emission measurement. In that case, the tuning of the sample and the detection of the signal take place on different wavelengths. The tuning radiation is separated from the signal radiation by means of a cut-off filter (not shown) placed in front of the detector. The emission intensity is recorded using a wavelength band of an emission spectrum that is more sensitive to detecting the wear of the medium. Correlation with the degree of wear is obtained with the aid of a calibration operation performed beforehand and a numerical analysis method suitable for the purpose.

At its simplest, the numerical analysis method comprises the calculation of the ratio of the intensities and the detection of changes in this ratio. Instead of an absolute value proportional to the properties of the oil, the invention can also be easily used to determine the trend of the changes in the properties of the oil, which in itself tells a great deal about the state of change of the properties.

A great many emission signals are obtained from non-black oils (aromatics). The intensity diminishes with wear and the emission spectrum moves towards blue. In fluorescence measurement, the benefit of measurement between two gaps is less than above. In order to separate the signal from the tuning radiation, a suitable cut-off filter is required in front of the detector.

### Micro-Element (Example FIGS. 5a and 5b)

A micro-element, in which there are two electrodes is used in order to measure changes in the capacitance or resistance of the oil 50. It is attached to the measuring head 12 according to FIG. 1. The micro-element can be, for example, a comb-like pattern, in which the thickness of the pattern is in the order of 10-300 nm, the width of the line about 0.5-15 μm and the surface area of the entire pattern about 0.5*0.5-10*10 mm. In FIGS. 5a and 5b there are examples of the shapes of the micro-element 40, 40′.

The micro-element 40, 40′ can be manufactured, for example, on a glass base, on a semiconductor, or on plastic. A 50 nm-1 μm thick layer of aluminium is evaporated onto glass. On top of it are spread the desired resists, on which the desired pattern is exposed by electron-beam lithography. The pattern is etched into both the resists and the aluminium. The desired metals are evaporated according to the pattern onto the surface of the glass. Finally, the resists are removed and of the aluminium only the pattern remains. The micro-element detects changes in capacitance and resistance by measuring current. In the measurement of resistance, a direct voltage, or a low-frequency alternating voltage, and in the measurement of capacitance a high-frequency alternating voltage must be fed to the micro-element.

According to FIG. 3, the focusing means can includes, according to one embodiment, a lens system 52 fitted after the light source 16, which includes at least one lens. The lens 52 can be, for example, inside the end 16′ and can be, for example, a diffusion or generally a homogenizing lens 52. By means of it, the light can be made of equal quality for the optical-fibre conductors 18.1 and the various sensor 10 can be made as comparable as possible. Thus the measurement results obtained form devices 10 based on different optical-fibre technologies are made mutually comparable, i.e. independent of the measurement results obtained from the optical-fibre conductors 18.1, 18.2. In addition, the use of a diffusion lens 52 eliminates errors arising from the dispersion of the components. The optical-fibre bundles 18.1, 18.2 can be, for example, of glass or other optical fibres.

FIG. 8 shows an exploded view of an improved prototype of the device 10. The connecting screws of the components are not given reference numbers. The end of the device case 14 at the sensor-connector 46 side is closed by the back plate 51 of the sensor body equipped with a seal 49. At the end at the measuring-head 12 side there is a support 48 for the mirrors 22.1, 22.2. The plate capacitors 44 are separated from each other by insulator collars 47 while before the extreme end screw there is also an insulator collar 47. Otherwise the reference numbers are those given above.

The measuring variable can be either the measured intensity described above or alternatively also a variable proportional to it, for example, the current of the LED 16, if it is wished to keep the intensity constant. When the properties of the medium 50 change according to a set criterion, the magnitude of the current fed to the light source 16 can be increased. If, for example, the oil 50 is detected to be darkening, the LED current can be increased, in which case the current of the LED 16 with remain constant.

The ends of the fibre bundles formed of optical fibre 18.1, 18.2 can be ground flat. The bundle formed by the fibres can protrude from the end collar 16′, 20.1, 20.2 and then the bundle can be ground level with the end of the end collar 16′, 20.1, 20.2. When using glass fibres, the optical fibre 18, 18.1, 18.2 can be formed of, for example, 50-100 fibres, which are bound together by end collars 16′, 20.1, 20.2. It is also possible to use plastic fibres as the optical-fibre conductors. They have the advantage of not dispersing light at the end of the measuring gap 13.1, 13.2.

According to yet another embodiment, the digital reduction of the offset of the measuring signal can be performed already in the measuring head 12, as a result of which a stabilized/(digitally) calibrated measuring signal will be obtained. Several sensor devices 10 according to the invention can be connected in series. Data transmission can be handled using, for example, a MODBUS bus from the sensor connector interface 46 at the end of the case 14.

It must be understood that the above description and the related figures are only intended to illustrate the present invention. The invention is thus in no way restricted to only the embodiments disclosed or stated in the Claims, but many different variations and adaptations of the invention, which are possible within the scope on the inventive idea defined in the accompanying Claims, will be obvious to one versed in the art.

### REFERENCE

[1] Characterization of used mineral oil connection by spectroscopic techniques; APPLIED OPTICS/Vol. 43, No. 24/20 Aug. 2004, pages 4718-4722.

1. Method for monitoring the condition of a medium in a channel, based on the transmission/emission of light, in which
a light at a set wavelength is conducted through a medium layer defined by a measuring gap in a measuring head pushed in from an opening in the wall of the channel,
the intensity of the light passed through the medium layer, or a variable proportional to it is measured as a measuring variable, and
the condition relating to the aging phenomenon of the medium is evaluated from the change of the measuring variable, according to established criteria,
characterized characterized in that in the method
the wavelength of light used is such that the resolution of the aging phenomenon of the medium being monitored is optimal by the chosen measuring variable in which case the change of the measuring variable caused by the change of the aging phenomenon of the medium is detected and
the relationship of the temperature dependence of the medium to the measuring variable is taken into account.

2. Method according to claim 1, characterized in that the wavelength of the light is in the range 300 nm-600 nm.

3. Method according to claim 1, characterized characterized in that the wavelength of the light is in the range 400 nm-500 nm.

4. Method according to claim 1, characterized in that the wavelength of the light is selected on the basis of the medium being monitored.

5. Method according to claim 1, characterized in that the wavelength of the light is adapted according to the wavelength range/sensitivity characteristic for the fragmentation of the molecules of the medium.

6. Method according to claim 1, characterized in that in the method measurement-technical classification according to the temperature is implemented.

7. Method according to claim 1, characterized in that the wavelength range of the light is adjusted in connection with the measurement.

8. Method according to claim 1, characterized in that the intensity of the light conducted through the medium layer is adjusted in connection with the measurement.

9. Device for monitoring the condition of a medium in a channel, based on the transmission/emission of light, which device includes
a measuring head, which is arranged to be installed in an opening in the wall of the channel,
two measuring gaps in the measuring head, for performing a measurement at two different thicknesses of the layer of the medium,
a light source and means for forming a light beam according to the set wavelength and conducting it from the light source to the measuring gaps,
detecting means for measuring the intensities of the light beams passed through the two medium layers, or a variable proportional to it as a measuring variable,
measuring electronics, for analysing the intensity of the light passed through the medium layer, or the variable proportional to it, and for evaluating the change in the measuring variable, using a chosen numerical analysis method, which change is proportional to the condition relating to the aging phenomenon of the medium, characterized in that the light source is arranged to form the light at the wavelength at which the resolution of the aging phenomenon of the medium being monitored is optimal by the chosen measuring variable in which case the change of the measuring variable caused by the change of the aging phenomenon of the medium is arranged to be detected and the measuring electronics are arranged to take into account the relationship of the temperature dependence of the medium to the measuring variable.
